(19) United States
(12) Patent Application Publication
(10) Pub. No.: US 2010/0031930 A1
(43) Pub. Date: Feb. 11, 2010

(54) FUEL SYSTEM FOR SELECTIVELY PROVIDING FUEL TO AN ENGINE AND A REGENERATION SYSTEM

(75) Inventors: Daniel R. Ibrahim, Metamora, IL (US); Steven Y. Tian, Bloomington, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/186,554

(22) Filed: Aug. 6, 2008

(51) Int. Cl. F02M 37/08

(52) U.S. Cl. 123/497

(57) ABSTRACT

A fuel system for providing fuel to an engine and to a regeneration system associated with the engine, including a fuel source, and a pump associated with the fuel source, the pump operable in a first state to pump fuel from the fuel source to the engine, and the pump operable in a second state to pump fuel from the fuel source to the regeneration system, wherein the first state corresponds to a first rotational direction of the pump and the second state corresponds to a second rotational direction of the pump. In one embodiment, the pump is an electric fuel pump.

### TECHNICAL FIELD

The present disclosure relates to a fuel system, and, more particularly, to a fuel system including a fuel pump for selectively providing fuel to an engine priming system and a regeneration system associated with the engine.

### BACKGROUND

Some engines use fuel injection systems to introduce fuel into the engine for priming purposes and/or into a regeneration system associated with the engine. The fuel injection system may be any one of various types of fuel systems and may include, within the system, a number of fuel injectors and at least one fuel pump. A fuel pump may be used to draw fuel from a fuel source, such as a fuel tank mounted on the engine, and distribute the fuel to the engine for such purposes as priming. A fuel pump may also be used to draw fuel from the fuel source and distribute the fuel to the regeneration system associated with the engine.

U.S. Pat. No. 5334,161 (the '161 patent), issued on Jul. 9, 1996 in the name of Tarr et al. and assigned to Cummins Engine Company, Inc., discloses a water drain and fuel-priming pump for a fuel system. The '161 patent discloses a reversible pump which is operable in a first direction to pump separated water out of a fuel filter and into a water drain, and which is operable in a second, opposite direction to pump fuel into the fuel filter in order to prime the fuel pump. The '161 patent, however, fails to provide a mechanism for providing fuel to a regeneration system associated with the engine. The reversible pump disclosed in the '161 patent, requires a secondary, additional pump in order to pump fuel to a regeneration system.

The disclosed fuel system is directed to improvements in the existing technology.

### SUMMARY

In one aspect, the present disclosure is directed toward a fuel system for providing fuel to an engine and to a regeneration system associated with the engine, including a fuel source; and a pump associated with the fuel source, the pump operable in a first state to pump fuel from the fuel source to the engine, and the pump operable in a second state to pump fuel from the fuel source to the regeneration system, wherein the first state corresponds to a first rotational direction of the pump and the second state corresponds to a second rotational direction of the pump.

In another aspect, the present disclosure is directed toward a method of selectively providing fuel to an engine and a regeneration system, the method including providing an electric fuel pump associated with the engine and the regeneration system; providing a fuel source fluidly connected to the pump; drawing fuel from the fuel source to the pump; and selectively directing fuel from the pump to the engine when the pump is in a first state and to the regeneration system when the pump is in a second state, wherein the first state corresponds to a first rotational direction of the pump and the second state corresponds to a second rotational direction of the pump.

In yet another aspect, the present disclosure is directed toward a machine, including an engine configured to generate a power output; a regeneration system associated with the engine; and a fuel system configured, to selectively provide fuel to the engine and the regeneration system, the fuel system including a fuel source; and an electric fuel pump associated with the fuel source, the pump operable in a first state to pump fuel from the fuel source to the engine, and the pump operable in a second state to pump fuel from the fuel source to the regeneration system, wherein the first state corresponds to a first rotational direction of the pump and the second state corresponds to a second rotational direction of the pump.

### BRIEF DESCRIPTION OF THE DRAWINGS

FIG. 1 is a schematic and diagrammatic illustration of an exemplary fuel system for an engine.

### DETAILED DESCRIPTION

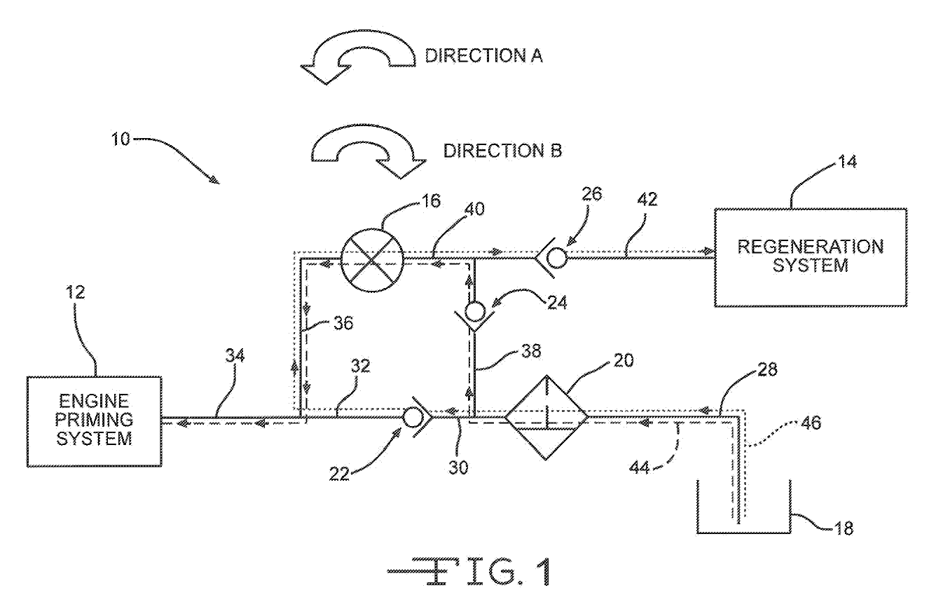

FIG. 1 illustrates a fuel system 10 which may be used to selectively provide fuel to an engine priming system 12 and a regeneration system 14. The fuel system 10 includes a reversible electric fuel pump 16 that provides directional control for the fuel through the fuel system 10, a filter 20 that provides filtration for the fuel in the fuel system 10, and a fuel tank or fuel source 18 that provides a supply of fuel for the fuel system 10. The fuel system also includes a plurality of check valves 22, 24, 26 and a plurality of fuel lines 28, 30, 32, 34, 36, 38, 40, 42 as described in detail below. Check valves 22, 24, 26 may be one-way check valves such that fluid flowing through the check valve can only pass through in one direction and flow of fluid in the opposite direction is prevented.

In an exemplary embodiment, the reversible pump 16 includes a direct current (DC) motor that can be operated in a first rotational direction and in a second, opposite rotational direction. The first rotational direction corresponds to the arrow in FIG. 1 labeled “Direction A” and the second rotational direction corresponds to the arrow in FIG. 1 labeled “Direction B”. Each rotational operational direction of the motor corresponds to a direction of flow of fuel through the reversible pump 16, as described, below. Even though described throughout as including a DC motor, the reversible pump 16 may include any other mechanism that provides opposite rotational directions for operating the reversible pump 16.

When the reversible pump 16 is operated in Direction A, the fuel in the fuel system 10 generally follows a dashed-line fuel path 44 and flows through the reversible pump 16 from right to left as shown in FIG. 1. The rotation of the motor in the reversible pump 16 in Direction A draws fuel from the fuel tank 18 towards the reversible pump 16 and out of the reversible pump 16 towards the engine priming system 12 in the following manner. The fuel exits the fuel tank 18 via the fuel line 28 and is routed through the filter 20. The fuel then is routed to the cheek valve 24 via the fuel line 38. The rotation of the reversible pump 16 continues to draw the fuel towards the reversible pump 16 and the fuel enters the reversible pump 16 via the fuel line 40 after exiting the check valve 24. The rotation of the reversible pump 16 forces the fuel out of the reversible pump 16 into the fuel line 36 and the fuel line 34 until the fuel reaches the engine priming system 12. The fuel is prevented from reentering the remainder of the fuel system 10 via the check valve 22.

When the reversible pump 16 is operated in Direction B, the fuel in the fuel system 10 generally follows a dashed-line fuel path 46 and flows through the reversible pump 16 from left to right as shown in FIG. 1. The rotation of the motor in the reversible pump 16 in Direction B draws fuel from the fuel tank 18 towards the reversible pump 16 and out of the reversible pump 16 towards the regeneration system 14 in the following manner. The fuel exits the fuel tank 18 via the fuel line 28 and is routed through the filter 20. The fuel then is routed to the check valve 22 via the fuel line 30. The rotation of the reversible pump 16 continues to draw the fuel towards the reversible pump 16 and the fuel exits check valve 22 and continues through the fuel lines 32, 36 towards the reversible pump 16. The fuel enters the reversible pump 16 and the rotation of the reversible pump 16 forces the fuel through the reversible pump 16 into the fuel line 40. The fuel continues to the cheek valve 26 via the fuel line 40 and exits the check valve 26 and continues through the fuel line 42 until the fuel reaches the regeneration system 14. The fuel is prevented from reentering the remainder of the fuel system 10 via the check valve 26.

### INDUSTRIAL APPLICABILITY

The disclosed fuel system may be applicable to any engine that includes an engine priming system and a regeneration system.

In operation, an electronic control module (ECM) or other controller associated with the engine provides a control signal to the reversible pump 16. When fuel is desired to be delivered to the engine priming system 12, the ECM provides a control signal to the reversible pump 16 such that the motor of the reversible pump 16 is operated in Direction A. When fuel is desired to be delivered to the regeneration system 14, the ECM provides a control signal to the reversible pump 16 such that the motor of the reversible pump 16 is operated in Direction B. An operator of a machine employing the engine may indicate to the ECM a desired fuel path via switches provided on the machine. Alternatively, the engine ECM may independently determine when to activate and/or reverse the operational direction of the reversible pump 16.

It will be apparent to those skilled in the art that various modifications and variations can be made to the disclosed fuel system without departing from the scope of the disclosure. Other embodiments of the fuel system will be apparent to those skilled in the art from consideration of the specification and practice of the fuel system disclosed herein. It is intended that the specification and examples be considered as exemplary only, with a true scope of the disclosure being indicated by the following claims and their equivalents.

What is claimed is:

1. A fuel system for providing met to an engine and to a regeneration system associated with the engine, comprising:
a fuel source; and
a pump associated with the fuel source, the pump operable in a first state to pump fuel from the fuel source to the engine, and the pump operable in a second state to pump fuel from the fuel source to the regeneration system, wherein the first state corresponds to a first rotational direction of the pump and the second state corresponds to a second rotational direction of the pump.

2. The fuel system of claim 1, wherein the pump includes a direct-current motor.

3. The fuel system of claim 1, wherein the pump includes an electric fuel pump.

4. The fuel system of claim 1, further including a check valve and a filter, wherein when the pump is operated in the first state, the fuel source, the filter, the check valve, the pump, and the engine are arranged serially.

5. The fuel system of claim 1, further including a first cheek valve, a second check valve, and a filter, wherein when the pump is operated in the second state, the fuel source, the filter, the first check valve, the pump, the second check valve, and the regeneration system are arranged serially.

6. The fuel system of claim 5, wherein the first check valve is positioned between the filter and the pump, and wherein the second check valve is positioned between the pump and the regeneration system.

7. The fuel system of claim 1, further including a check valve positioned between the pump and the regeneration system, wherein the check valve allows one-way passage of fuel from the pump to the regeneration system.

8. The fuel system of claim 1, further including a cheek valve positioned between the pump and the fuel source.

9. The fuel system of claim 1, further including a filter positioned between the fuel source and the pump.

10. A method of selectively providing fuel to an engine and a regeneration system, the method comprising:
providing an electric fuel pump associated with the engine and the regeneration system;
providing a fuel source fluidly connected to the pump;
drawing fuel from the fuel source to the pump; and
selectively directing fuel from the pump to the engine when the pump is in a first state and to the regeneration system when the pump is in a second state, wherein the first state corresponds to a first rotational direction of the pump and the second state corresponds to a second rotational direction of the pump.

11. The method of claim 10, wherein the drawing step includes filtering fuel.

12. The method of claim 10, wherein when the pump is in the first state, the selectively directing step includes the steps of filtering fuel routing fuel through a check valve, routing fuel through the pump, and directing the fuel from the pump to the engine.

13. The method of claim 10, wherein when the pump is in the second state, the selectively directing step includes the steps of filtering fuel, routing fuel through a first check valve, routing fuel through the pump, routing fuel through a second check valve, and directing the fuel to the regeneration system.

14. The method of claim 13, wherein the first check valve is positioned between tire pump and the fuel source.

15. The method of claim 13, wherein the second check valve is positioned between the pump and the regeneration system.

16. The method of claim 13, wherein the second check valve prevents fuel from exiting the regeneration system and returning to the pump.

17. A machine, comprising:
an engine configured to generate a power output;
a regeneration system associated with the engine; and
a fuel system configured to selectively provide fuel to the engine and the regeneration system, the fuel system including:
a fuel source; and
an electric fuel pump associated with the fuel source, the pump operable in a first state to pump fuel from the fuel source to the engine, and the pump operable in a second state to pump fuel from the fuel source to the regeneration system, wherein the first state corresponds to a first rotational direction of the pump and the second state corresponds to a second rotational direction of the pump.

18. The machine of claim 17, wherein the pump includes a direct-current motor.

19. The machine of claim 17, further including a check valve and a filter, wherein when the pump is operated in the first state, the fuel source, the filter, the check valve, the pump, and the engine are arranged serially.

20. The machine of claim 17, further including a first check valve, a second check valve, and a filter, wherein when the pump is operated in the second state, the fuel source, the filter, the first check valve, the pump, the second check valve, and the regeneration system are arranged serially.
